(19) United States
(12) Patent Application Publication
(10) Pub. No.: US 2025/0326965 A1
(43) Pub. Date: Oct. 23, 2025

(54) AMPHIPHILIC TITANIUM DIOXIDE NANOMATERIAL AND ITS PREPARATION METHOD AND APPLICATION

(71) Applicant: CHINA UNIVERSITY OF PETROLEUM—BEIJING, Beijing (CN)

(72) Inventors: Jirui HOU, Beijing (CN); Zhuo LU, Beijing (CN)

(73) Assignee: CHINA UNIVERSITY OF PETROLEUM—BEIJING, Beijing (CN)

(21) Appl. No.: 18/800,409

(22) Filed: Aug. 12, 2024

(30) Foreign Application Priority Data
Apr. 19, 2024 (CN) 202410473861.5

(51) Int. Cl. C09K 8/584; C01G 23/08; E21B 43/16

(52) U.S. Cl. CPC C09K 8/584; C01G 23/08; E21B 43/16; C01P 2004/24; C01P 2004/64; C01P 2006/12; C09K 2208/10

(57) ABSTRACT

An amphiphilic titanium dioxide nanomaterial and its preparation method and application. The amphiphilic titanium dioxide nanomaterial includes an anatase titanium dioxide nanosheet and a carbon chain grafted on at least part of the surface of the anatase titanium dioxide nanosheet via an ester bond, where, a carbon atom number of the carbon chain is 8-30, and a grafting ratio is 5%-45%. The amphiphilic titanium dioxide nanomaterial provided can improve the oil recovery.

### CROSS-REFERENCE TO RELATED APPLICATION

This application claims priority to Chinese Patent Application No. 202410473861.5, filed on Apr. 19, 2024, which is incorporated by reference in its entirety.

### TECHNICAL FIELD

The present disclosure relates to an amphiphilic titanium dioxide nanomaterial and its preparation method and application, which belongs to the technical field of petroleum extraction.

### BACKGROUND

Petroleum resources have always been one of the indispensable energy sources in the development of human society. With the continuous extraction of oilfield and the reduction of newly discovered reserves, how to extract crude oil that accounts for more than 60% of the original underground reserves and cannot be extracted by conventional methods and to improve the crude oil extraction efficiency has become a common concern for countries around the world.

At present, nanomaterials are commonly used instead of traditional surfactants for oilfield extraction. Nanomaterials have the characteristics of reducing interfacial tension, changing rock wettability, reducing crude oil viscosity, and generating structural separation pressure. However, the nanomaterials currently used still have the defect of limited effect of enhancing oil recovery.

### SUMMARY

The present disclosure provides an amphipathic titanium dioxide nanomaterial, which can significantly improve the oil recovery when used in oilfield extraction.

The present disclosure provides a preparation method of an amphipathic titanium dioxide nanomaterial. The amphiphilic titanium dioxide nanomaterial prepared by the preparation method can significantly improve the oil recovery, and has a simple and controllable process, which is conducive to achieving large-scale production.

The present disclosure provides a nanofluid, including the foregoing amphiphilic titanium dioxide nanomaterial, which can effectively enhance oil recovery and improve the efficiency of oil extraction operations.

The present disclosure provides a method for oil recovery, which achieves oil recovery through a nanofluid including an amphiphilic titanium dioxide nanomaterial, with an excellent oil recovery rate.

An aspect of the present disclosure provides an amphiphilic titanium dioxide nanomaterial, which includes an anatase titanium dioxide nanosheet and a carbon chain grafted on a surface of the anatase titanium dioxide nanosheet via an ester bond, where the carbon chain has a carbon atom number of 8-30, and a grafting ratio of the amphiphilic titanium dioxide nanomaterial is 5%-45%.

For the amphiphilic titanium dioxide nanomaterial as mentioned above, the carbon chain has a carbon atom number of 10-26.

For the amphiphilic titanium dioxide nanomaterial as mentioned above, the grafting ratio of the amphiphilic titanium dioxide nanomaterial is 5%-35%.

For the amphiphilic titanium dioxide nanomaterial as mentioned above, a contact angle of the amphiphilic titanium dioxide nanomaterial is 0-70°.

A further aspect of the present disclosure provides a preparation method of the amphiphilic titanium dioxide nanomaterial as mentioned above, which includes the following steps:
reacting a mixture containing 1 part by weight of an anatase titanium dioxide nanosheet, 2-20 parts by weight of a fatty acid compound and a solvent at 40-80° C. and 100-1000 rpm for 4-24 h, washing and filtering to obtain an amphiphilic titanium dioxide nanomaterial;
where, the fatty acid compound has a carbon atom number of 8-30.

For the preparation method as mentioned above, the fatty acid compound is 4-15 parts by weight.

For the preparation method as mentioned above, a reaction temperature is 60-80° C., a reaction rotation speed is 200-800 rpm, and a reaction time is 6-12 h.

A further aspect of the present disclosure provides a nanofluid, including the amphiphilic titanium dioxide nanomaterial as mentioned above and a solvent, where the solvent includes one of saline water and deionized water.

For the nanofluid as mentioned above, the amphiphilic titanium dioxide nanomaterial has a concentration of 10-1000 mg/L.

A further aspect of the present disclosure provides an oil recovery method, recovering an oil reservoir by the nanofluid as mentioned above.

The amphipathic titanium dioxide nanomaterial provided by the present disclosure takes the anatase titanium dioxide nanosheet as a matrix, and the carbon chain with a specific special number of carbon atoms is grafted on at least part of the surface of the anatase titanium dioxide nanosheet via an ester bond, the grafting ratio being defined. Where, the anatase titanium dioxide nanosheet is hydrophilic, while the carbon chain grafted on the surface of anatase titanium dioxide nanosheet via the ester bond is hydrophobic. When the amphipathic titanium dioxide nanomaterial is applied to the nanofluid, under the synergistic effect of the anatase titanium dioxide nanosheet and the carbon chain, the double property of hydrophilic and oleophilic characteristics is realized, and the oil/water interfacial tension is reduced, thus improving the oil recovery.

The preparation method of the amphipathic titanium dioxide nanomaterial provided by the present disclosure is used for preparing the amphipathic titanium dioxide nanomaterial, where the preparation process does not need complicated technological conditions, and is highly reproducible.

The nanofluid provided by the present disclosure includes the amphiphilic titanium dioxide nanomaterial, thus the nanofluid has lower oil/water interfacial tension, which is beneficial to improving the oil recovery.

The oil recovery method provided by the present disclosure uses the above nanofluid, thus the oil recovery method has higher oil recovery efficiency when being used for oilfield extraction.

### DETAILED DESCRIPTION OF EMBODIMENTS

To make the objectives, technical solutions, and advantages of the present disclosure clearer, the following clearly and comprehensively describes the technical solutions in embodiments of the present disclosure with reference to the embodiments of the present disclosure. Apparently, the described embodiments are merely a part rather than all embodiments of the present disclosure. All other embodiments obtained by persons of ordinary skill in the art based on embodiments of the present disclosure without creative effort shall fall within the protection scope of the present disclosure.

An aspect of the present disclosure provides an amphiphilic titanium dioxide nanomaterial, which includes an anatase titanium dioxide nanosheet and a carbon chain grafted on a surface of the anatase titanium dioxide nanosheet via an ester bond, where the carbon chain has a carbon atom number of 8-30, and a grafting ratio of the amphiphilic titanium dioxide nanomaterial is 5%-45%.

The amphiphilic titanium dioxide nanomaterial provided by the present disclosure is obtained by modifying the anatase titanium dioxide nanosheet with monohydric fatty acid compound. During the modification, esterification reaction occurs between a carboxyl group in the fatty acid compound and a hydroxyl group on the surface of the anatase titanium dioxide nanosheet, and a carbon chain is grafted on at least part of the surface of the anatase titanium dioxide nanosheet through a ester bond, so that the amphiphilic titanium dioxide material have obvious hydrophilic and oleophilic characteristics.

The present disclosure does not limit the channels for obtaining the anatase titanium dioxide nanosheet, which can be obtained by commercial purchase or can be prepared in-house.

In a specific implementation, an anatase titanium dioxide nanosheet is obtained by in-house preparation. A preparation process is as follows: adding 1 part by weight of a titanium source to a solution containing 0.05-1 part by weight of hydrofluoric acid, mixing under stirring, and reacting with a rotation speed of 100-500 rpm at 120-240° C. for 6-24 hours, and cooling to room temperature, and then washing by a common detergent, filtering, and drying, to obtain the anatase titanium dioxide nanosheet.

The titanium source in the present disclosure includes but is not limited to at least one of titanium tetrachloride, titanium isopropanol, titanium tetrafluoride, and tetrabutyl titanate.

The carbon chain which is grafted on a surface of the anatase titanium dioxide nanosheet via an ester bond has a carbon atom number of 8-30, for example, the carbon atom number includes but is not limited to 8, 10, 12, 14, 16, 18, 20, 22, 24, 26, 28, 30, or a value within a range consisting of any two of them.

The present disclosure does not limit the specific form and saturation of carbon chain, and suitable carbon chain types can be selected according to the actual situation. The carbon chain may be a linear chain or may include a partially-branched chain; the carbon chain may be either a saturated carbon chain or an unsaturated carbon chain.

In a specific implementation, the carbon chain is a saturated linear chain.

The grafting ratio in the present disclosure refers to a ratio of a number of carbon chain successfully grafted on the surface of the anatase titanium dioxide nanosheet as a matrix to a theoretical maximum number of carbon chain grafted on the surface of the anatase titanium dioxide nanosheet, in the process of modifying the anatase titanium dioxide nanosheet to prepare the amphiphilic titanium dioxide nanomaterial using the fatty acid compound.

The grafting ratio in the present disclosure is determined by testing a concentration difference of the fatty acid compound before and after the reaction. That is to say, a concentration of the fatty acid compound tested by Ultraviolet Detection before the reaction is W1, a concentration of the fatty acid compound after the reaction is W2, and a maximum concentration of the fatty acid compound that is fully grafted is W3, then a concentration of the fatty acid compound consumed by grafting is expressed as the concentration difference of the fatty acid compound before and after the reaction, i.e., W₀=W₁-W_{2,} and the grafting ratio is expressed as W=W₀/W₃.

The grafting ratio of the amphiphilic titanium dioxide nanomaterial provided by the present disclosure is 5%-45%, for example, the grafting ratio includes but is not limited to 5%, 10%, 15%, 20%, 25%, 30%, 35%, 40%, 45%, or a value within a range consisting of any two of them.

The present disclosure does not limit specific parameters of the amphiphilic titanium dioxide nanomaterial such as specific surface area, thickness, and side length, which can be selected to be in a suitable parameter range according to actual requirements.

In a specific implementation, the amphiphilic titanium dioxide nanomaterial has a specific surface area of 80-150 m²/g, a thickness of 2-4 nm, and a side length of 10-30 nm.

The specific surface area of the amphiphilic titanium dioxide nanomaterial in the present disclosure refers to an average specific surface area of the same batch of the amphiphilic titanium dioxide nanomaterials, which is detected by a specific surface area analysis tester.

The thickness and side length of the amphiphilic titanium dioxide nanomaterial in the present disclosure refer to an average thickness and an average side length measured from the same batch of the amphiphilic titanium dioxide nanomaterials respectively. The present disclosure does not limit specific measurement methods, and the average thickness and the average side length can be obtained by common measurement methods in the art.

It can be understood that the size parameters such as the specific surface area, thickness, and side length of the amphiphilic titanium dioxide nanomaterial are identical to those of the anatase titanium dioxide nanosheet as the matrix at the nanoscale. The specific surface area, the thickness, and the side length of the anatase titanium dioxide nanosheet can be controlled through specific reaction conditions, thereby controlling the specific surface area, the thickness, and the side length of the amphiphilic titanium dioxide nanomaterial.

In a specific implementation, the anatase titanium dioxide nanosheet is obtained by the following: adding 1 part by weight of the titanium source to a solution containing 0.05-0.5 part by weight of hydrofluoric acid, mixing under stirring, and reacting with a rotation speed of 200-500 rpm at 160-200° C. for 12-24 hours, and cooling to room temperature, and then washing by a common organic solvent and deionized water, filtering, and drying.

By controlling specific rotation speed range, reaction temperature, reaction time and other process condition, and the parameters of the anatase titanium dioxide nanosheet such as the specific surface area, the thickness, and the side length may be effectively controlled.

The amphiphilic titanium dioxide nanomaterial provided by the present disclosure has lower oil/water interfacial tension when being used for oil recovery; and can significantly improve the oil recovery. According to the analysis of the inventor, the reason may be that the anatase titanium dioxide nanosheet as a matrix has a certain size effect, showing obvious hydrophilic and oleophobic characteristics, while the carbon chain grafted on the surface of the anatase titanium dioxide nanosheet via the ester bond is oleophilic and hydrophobic; by limiting the carbon chain with a specific carbon atom number and a specific grafting ratio, the synergistic effect between the anatase titanium dioxide nanosheet and the carbon chain grafted on the surface of the anatase titanium dioxide nanosheet via the ester bond can be fully exerted, thereby reducing the interfacial tension between oil and water, and improving the oil recovery.

Furthermore, in a specific implementation of the present disclosure, the carbon chain has a carbon atom number of 10-26.

Specifically, a carbon chain has a carbon atom number of 10-26. For example, the carbon atom number includes but is not limited to a range of 10, 11, 12, 13, 14, 15, 16, 17, 18, 19, 20, 21, 22, 23, 24, 25, 26, or a value within a range consisting of any two of them.

When the carbon atom number of the carbon chain is within the above range, in the amphiphilic titanium dioxide nanomaterial, the hydrophilic characteristics of the anatase titanium dioxide nanosheet matrix can achieve a better balance with the oleophilic characteristics of the carbon chain, which causes the nanofluid containing the amphiphilic titanium dioxide nanomaterial to have lower oil/water interfacial tension, improving the oil recovery.

Furthermore, in a specific implementation of the present disclosure, the grafting ratio of the amphiphilic titanium dioxide nanomaterial is 5%-35%.

Specifically, the grafting ratio of the amphiphilic titanium dioxide nanomaterial is 5%-35%. For example, the grafting ratio includes but is not limited to 5%, 10%, 15%, 20%, 25%, 30%, 35%, or a value within a range consisting of any two of them.

When the amphiphilic titanium dioxide nanomaterial with the above grafting ratio is used for oil extraction, there is a higher oil recovery. The reason may be that at this grafting ratio, the hydrophilic characteristic of the anatase titanium dioxide nanosheet achieves a balance with the hydrophobic characteristics of the carbon chain, resulting in higher interfacial activity of the amphiphilic titanium dioxide nanomaterial, which helps to reduce oil-water interfacial tension, emulsify crude oil, and improve the oil recovery.

Furthermore, in a specific implementation of the present disclosure, a contact angle of the amphiphilic titanium dioxide nanomaterial is 0-70°.

The contact angle of the present disclosure refers to an angle formed by pressing the amphiphilic titanium dioxide nanomaterial into a sheet and adding a deionized water droplet onto the sheet.

Specifically, the contact angle of the amphiphilic titanium dioxide nanomaterial is 0-70°. For example, the contact angle includes but is not limited to 0°, 10°, 20°, 30°, 40°, 50°, 60°, 70°, or a value within a range consisting of any two of them.

When the contact angle is within the above range, the amphiphilic titanium dioxide nanomaterial exhibits excellent hydrophilic and oleophilic characteristics, with a high oil recovery.

A further aspect of the present disclosure provides a preparation method of the foregoing amphipathic titanium dioxide nanomaterial, including the following steps:
reacting a mixture containing 1 part by weight of an anatase titanium dioxide nanosheet, 2-20 parts by weight of a fatty acid compound and a solvent at 40-80° C. with a rotation speed of 100-1000 rpm for 4-24 h, washing and filtering, to obtain the amphiphilic titanium dioxide nanomaterial, where the carbon atom number of the fatty acid compound is 8-30.

Specifically, the amphiphilic titanium dioxide nanomaterial is obtained by the following: mixing 1 part by weight of the anatase titanium dioxide nanosheet with 2-20 parts by weight of the fatty acid compound with 8-30 carbon atoms and the solvent to obtain a mixture, and reacting the mixture at 40-80° C. with the rotation speed of 100-1000 rpm for 4-24 h to cause the esterification reaction between the carboxyl group in the fatty acid compound and the hydroxyl group on the surface of the anatase titanium dioxide nanosheet, and then washing by a common detergent and filtering.

The fatty acid compound in the present disclosure refers to a monohydric fatty acid compound.

Specifically, the part by weight of the fatty acid compound includes but is not limited to 2, 4, 6, 8, 10, 12, 14, 16, 18, 20, or a value within a range consisting of any two of them.

The reaction temperature includes but is not limited to 40° C., 45° C., 50° C., 55° C., 60° C., 65° C., 70° C., 75° C., 80° C., or a value within a range consisting of any two of them.

The rotational speed includes but is not limited to 100 rpm, 200 rpm, 300 rpm, 400 rpm, 500 rpm, 600 rpm, 700 rpm, 800 rpm, 900 rpm, 1000 rpm, or a value within a range consisting of any two of them.

The reaction time includes but is not limited to 4 h, 5 h, 6 h, 7 h, 8 h, 9 h, 10 h, 11 h, 12 h, 13 h, 14 h, 15 h, 16 h, 17 h, 18 h, 19 h, 20 h, 21 h, 22 h, 23 h, 24 h, or a value within a range consisting of any two of them.

In another specific implementation, the amphiphilic titanium dioxide nanomaterial is obtained by the following: mixing 1 part by weight of the anatase titanium dioxide nanosheet with 2-20 parts by weight of the fatty acid compound with 8-30 carbon atoms and the solvent, to obtain a mixture, and reacting the mixture at 60-80° C. with the rotation speed of 200-800 rpm for 6-12 h, to cause the esterification reaction between the carboxyl group in the fatty acid compound and the hydroxyl group on the surface of the anatase titanium dioxide nanosheet, and then washing by the common detergent and filtering.

The present disclosure does not limit a specific type of the solvent, as long as it can provide a good liquid modification environment for the anatase titanium dioxide nanosheet and the fatty acid compound, such as toluene, cyclohexane, n-heptane, etc.

The present disclosure does not limit a specific type of the detergent, and the common detergents in the art can be used, such as ethanol, deionized water, etc.

The preparation method provided by the present disclosure can prepare the foregoing amphiphilic titanium dioxide nanomaterial and is simple and controllable in preparation process, which is conducive to achieving large-scale production.

Furthermore, in a specific implementation of the present disclosure, the part by weight of the fatty acid compound is 4-15.

Specifically, the part by weight of the fatty acid compound includes but is not limited to 4, 5, 6, 7, 8, 9, 10, 11, 12, 13, 14, 15, or a range of any two of them.

When the part by weight of the fatty acid compound is within the above range, the amphiphilic titanium dioxide nanomaterial prepared by the foregoing preparation method has a relatively suitable grafting ratio and excellent oil recovery when used for oil extraction.

Furthermore, in a specific implementation of the present disclosure, the reaction temperature is 60-80° C., the reaction rotation speed is 200-800 rpm, and the reaction time is 6-12 h.

Specifically, the reaction temperature is between 60-80° C. For example, the reaction temperature includes but is not limited to 60° C., 65° C., 70° C., 75° C., 80° C., or a range of any two of them.

The reaction rotation speed includes but is not limited to 200 rpm, 300 rpm, 400 rpm, 500 rpm, 600 rpm, 700 rpm, 800 rpm or a range of any two of them.

The reaction time includes but is not limited to a range of 6 h, 7 h, 8 h, 9 h, 10 h, 11 h, 12 h, or a range of any two of them.

When the reaction conditions are within the above range, the modification reaction between the fatty acid compound and the anatase titanium dioxide nanosheet can be effectively controlled, so that the amphiphilic titanium dioxide nanomaterial finally prepared has good oil recovery.

A further aspect of the present disclosure provides a nanofluid, including the amphiphilic titanium dioxide nanomaterial and a solvent, where the solvent includes one of saline water and deionized water.

Specifically, the amphipathic titanium dioxide nanomaterial is mixed with the solvent to obtain the nanofluid, where the solution includes the saline water or the deionized water.

In the present disclosure, the type of a salt compound in the saline water is not specifically limited, and the common salt compounds in the art can be selected, such as at least one of sodium sulfate, sodium bicarbonate, sodium chloride, calcium chloride and magnesium chloride.

The saline water in the present disclosure can be prepared by commercially purchased salt compounds and water, and can also utilize the oilfield produced water, thereby further reducing the production cost.

The present disclosure limits a specific concentration of the saline water, and an appropriate concentration of saline water can be selected according to the actual situation, for example, the concentration of saline water is not higher than 350000 mg/L.

Since the nanofluid provided by the present disclosure includes the foregoing amphiphilic titanium dioxide nanomaterial, the nanofluid has lower oil/water interfacial tension and higher dispersion stability, which can significantly improve oil recovery rate when used for oil recovery.

Furthermore, in a specific implementation of the present disclosure, a concentration of the amphiphilic titanium dioxide nanomaterial is 10-1000 mg/L.

The concentration of the amphiphilic titanium dioxide nanomaterial in the nanofluid can be controlled by a mass to volume ratio of the amphiphilic titanium dioxide nanomaterial to the solvent.

Specifically, the concentration of the amphiphilic titanium dioxide nanomaterial includes but is not limited to 10 mg/L, 50 mg/L, 100 mg/L, 150 mg/L, 200 mg/L, 250 mg/L, 300 mg/L, 350 mg/L, 400 mg/L, 450 mg/L, 500 mg/L, 650 mg/L, 700 mg/L, 850 mg/L, 900 mg/L, 950 mg/L, 1000 mg/L, or a value within a range consisting of any two of them.

When the concentration of the amphiphilic titanium dioxide nanomaterial is within the above range, the oil/water interfacial tension of the nanofluid is low, which can achieve effective contact between the nanofluid and the crude oil in the reservoir, and ensure good dispersion of the amphiphilic titanium dioxide nanomaterial in the nanofluid, further improving the oil recovery.

A further aspect of the present disclosure provides an oil recovery method, recovering an oil reservoir by the foregoing nanofluid.

Specifically, the foregoing nanofluid is continuously or alternately injected into the oil reservoir to reduce the interfacial tension between the oil reservoir and water, improving the oil displacement efficiency and thus enhancing oil recovery and achieving oil reservoir exploitation.

The nanofluid including the amphiphilic titanium dioxide nanomaterial of the present disclosure is described in detail below through specific examples.

### Example 1

Preparation methods for an anatase titanium dioxide nanosheet, an amphiphilic titanium dioxide nanomaterial, and a nanofluid provided in this example are specifically as follows.

1. Preparation of the anatase titanium dioxide nanosheet: adding 1 part by weight of titanium tetrachloride to a solution containing 0.3 parts by weight of hydrofluoric acid, mixing under stirring, reacting a mixture for 16 with a rotation speed of 300 rpm at a temperature of 180° C., and cooling to room temperature, washing with a deionized water and filtering, and drying to obtain the anatase titanium dioxide nanosheet.

2. Preparation of the amphiphilic titanium dioxide nanomaterial: reacting a mixture including 1 part by weight of the anatase titanium dioxide nanosheet, 10 parts by weight of a fatty acid compound with 20 carbon atoms and a solvent at 70° C. with a rotation speed of 600 rpm for 10 h, then washing and filtering to obtain the amphiphilic titanium dioxide nanomaterial, where, according to measurements, the prepared amphiphilic titanium dioxide nanomaterial has a grafting ratio of 20%, a contact angle of 32°, a specific surface area of 99.23 m²/g, a side length of 13.59 nm and a thickness of 2.6 nm.

The amphiphilic titanium dioxide nanomaterial provided in this example is mixed with the deionized water, followed by controlling a concentration of the amphiphilic titanium dioxide nanomaterial to be 50 mg/L, and performing ultrasonic treatment for 15 min to obtain the nanofluid.

### Example 2

Preparation methods for an anatase titanium dioxide nanosheet, an

amphiphilic titanium dioxide nanomaterial, and a nanofluid provided in this example are specifically as follows.

1. Preparation of the anatase titanium dioxide nanosheet: adding 1 part by weight of tetrabutyl titanate to a solution containing 0.05 parts by weight of hydrofluoric acid, mixing under stirring, reacting a mixture for 6 h with a rotation speed of 100 rpm at a temperature of 120° C., and cooling to room temperature, washing with a deionized water and filtering, and drying to obtain the anatase titanium dioxide nanosheet.

2. Preparation of the amphiphilic titanium dioxide nanomaterial: reacting a mixture including 1 part by weight of the above anatase titanium dioxide nanosheet, 2 parts by weight of a fatty acid compound with 8 carbon atoms and a solvent at 40° C. with a rotation speed of 1000 rpm for 4 h, then washing and filtering to obtain the amphiphilic titanium dioxide nanomaterial, where, according to measurements, the prepared amphiphilic titanium dioxide nanomaterial has a grafting ratio of 5.9%, a contact angle of 5°, a specific surface area of 84 m²/g, a side length of 23.5 nm and a thickness of 3.4 nm.

The amphiphilic titanium dioxide nanomaterial provided in this example is mixed with a saline water having a concentration of 10000 mg/L, followed by controlling a concentration of the amphiphilic titanium dioxide nanomaterial to be 50 mg/L, and performing ultrasonic treatment for 15 min to obtain the nanofluid.

### Example 3

Preparation methods for an anatase titanium dioxide nanosheet, an amphiphilic titanium dioxide nanomaterial, and a nanofluid provided in this example are specifically as follows.

1. Preparation of the anatase titanium dioxide nanosheet: adding 1 part by weight of titanium tetrafluoride to a solution containing 1 part by weight of hydrofluoric acid, mixing under stirring, reacting a mixture for 6 h with a rotation speed of 500 rpm at a temperature of 240° C., and cooling to room temperature, washing with a deionized water and filtering, and drying to obtain the anatase titanium dioxide nanosheet.

2. Preparation of the amphiphilic titanium dioxide nanomaterial: reacting a mixture including 1 part by weight of the above anatase titanium dioxide nanosheet, 20 parts by weight of a fatty acid compound with 30 carbon atoms and a solvent at 80° C. with a rotation speed of 100 rpm for 24 h, then washing and filtering to obtain the amphiphilic titanium dioxide nanomaterial, where, according to measurements, the prepared amphiphilic titanium dioxide nanomaterial has a grafting ratio of 45%, a contact angle of 66°, a specific surface area of 89 m²/g, a side length of 16.9 nm and a thickness of 2.2 nm.

The amphiphilic titanium dioxide nanomaterial provided in this example is mixed with the deionized water, followed by controlling a concentration of the amphiphilic titanium dioxide nanomaterial to be 1000 mg/L, and performing ultrasonic treatment for 15 min to obtain the nanofluid.

### Example 4

Preparation methods for an anatase titanium dioxide nanosheet, an amphiphilic titanium dioxide nanomaterial, and a nanofluid provided in this example are specifically as follows.

1. Preparation of the anatase titanium dioxide nanosheet: adding 1 part by weight of titanium isopropoxide to a solution containing 0.05 parts by weight of hydrofluoric acid, mixing under stirring, reacting a mixture for 12 h with a rotation speed of 200 rpm at a temperature of 200° C., and cooling to room temperature, washing with a deionized water and filtering, and drying to obtain the anatase titanium dioxide nanosheet.

2. Preparation of the amphiphilic titanium dioxide nanomaterial: reacting a mixture including 1 part by weight of the above anatase titanium dioxide nanosheet, 15 parts by weight of a fatty acid compound with 26 carbon atoms and a solvent at 60° C. with a rotation speed of 800 rpm for 12 h, then washing and filtering to obtain the amphiphilic titanium dioxide nanomaterial, where, according to measurements, the prepared amphiphilic titanium dioxide nanomaterial has a grafting ratio of 35%, a contact angle of 49°, a specific surface area of 87.33 m²/g, a side length of 13.59 nm and a thickness of 2.8 nm.

The amphiphilic titanium dioxide nanomaterial provided in this example is mixed with the deionized water, followed by controlling a concentration of the amphiphilic titanium dioxide nanomaterial to be 50 mg/L, and performing ultrasonic treatment for 15 min to obtain the nanofluid.

### Example 5

The preparation method of an anatase titanium dioxide nanosheet provided in this example is the same as that of Example 1; and the preparation method of an amphiphilic titanium dioxide nanomaterial is basically the same as that of Example 1, except that:
in step 2), a carbon atom number of the fatty acid compound is 10.

According to measurements, the prepared amphiphilic titanium dioxide nanomaterial has a grafting ratio of 20%, a contact angle of 38°, a specific surface area of 99.23 m²/g, a side length of 13.59 nm and a thickness of 2.6 nm.

The amphiphilic titanium dioxide nanomaterial provided in this example is mixed with the deionized water, followed by controlling a concentration of the amphiphilic titanium dioxide nanomaterial to be 50 mg/L, and performing ultrasonic treatment for 15 min to obtain the nanofluid.

### Example 6

The preparation method of an anatase titanium dioxide nanosheet provided in this example is the same as that of Example 1; and the preparation method of an amphiphilic titanium dioxide nanomaterial is basically the same as that of Example 1, except that:
in step 2), a carbon atom number of the fatty acid compound is 26.

According to measurements, the prepared amphiphilic titanium dioxide nanomaterial has a grafting ratio of 24%, a contact angle of 42°, a specific surface area of 99.23 m²/g, a side length of 13.59 nm and a thickness of 2.6 nm.

The amphiphilic titanium dioxide nanomaterial provided in this example is mixed with the deionized water, followed by controlling a concentration of the amphiphilic titanium dioxide nanomaterial to be 50 mg/L, and performing ultrasonic treatment for 15 min to obtain the nanofluid.

### Example 7

The preparation method of an anatase titanium dioxide nanosheet provided in this example is the same as that of Example 1; and the preparation method of an amphiphilic titanium dioxide nanomaterial is basically the same as that of Example 1, except that:
in step 2), a carbon atom number of the fatty acid compound is 8.

According to measurements, the prepared amphiphilic titanium dioxide nanomaterial has a grafting ratio of 19%, a contact angle of 18°, a specific surface area of 99.23 m²/g, a side length of 13.59 nm and a thickness of 2.6 nm.

The amphiphilic titanium dioxide nanomaterial provided in this example is mixed with the deionized water, followed by controlling a concentration of the amphiphilic titanium dioxide nanomaterial to be 50 mg/L, and performing ultrasonic treatment for 15 min to obtain the nanofluid.

### Example 8

The preparation method of an anatase titanium dioxide nanosheet provided in this example is the same as that of Example 1; and the preparation method of an amphiphilic titanium dioxide nanomaterial is basically the same as that of Example 1, except that:
in step 2), the part by weight of the fatty acid compound is 20.

According to measurements, the prepared amphiphilic titanium dioxide nanomaterial has a grafting ratio of 44%, a contact angle of 66°, a specific surface area of 99.23 m²/g, a side length of 13.59 nm and a thickness of 2.6 nm.

The amphiphilic titanium dioxide nanomaterial provided in this example is mixed with the deionized water, followed by controlling a concentration of the amphiphilic titanium dioxide nanomaterial to be 500 mg/L, and performing ultrasonic treatment for 15 min to obtain the nanofluid.

### Example 9

The preparation method of an anatase titanium dioxide nanosheet provided in this example is the same as that of Example 1, and the preparation method of an amphiphilic titanium dioxide nanomaterial is basically the same as that of Example 1, except that:
in step 2), the reaction temperature is 55° C., the rotation speed is 100 rpm, and the reaction time is 4 h.

According to measurements, the prepared amphiphilic titanium dioxide nanomaterial has a grafting ratio of 10%, a contact angle of 35°, a specific surface area of 99.23 m²/g, a side length of 13.59 nm and a thickness of 2.6 nm.

The amphiphilic titanium dioxide nanomaterial provided in this example is mixed with the deionized water, followed by controlling a concentration of the amphiphilic titanium dioxide nanomaterial to be 500 mg/L, and performing ultrasonic treatment for 15 min to obtain the nanofluid.

### Comparative Example 1

The preparation method of an anatase titanium dioxide nanosheet provided in this comparative example is the same as that of Example 1; and the preparation method of a titanium dioxide nanomaterial is basically the same as the preparation method of the amphiphilic titanium dioxide nanomaterial of Example 1, except that:
in step 2), a carbon atom number of the fatty acid compound is 6.

According to measurements, the prepared titanium dioxide nanomaterial has a grafting ratio of 20%, a contact angle of 8°, a specific surface area of 99.23 m²/g, a side length of 13.59 nm and a thickness of 2.6 nm.

The titanium dioxide nanomaterial provided in this comparative example is mixed with the deionized water, followed by controlling a concentration of the titanium dioxide nanomaterial to be 50 mg/L, and performing ultrasonic treatment for 15 min to obtain the nanofluid.

### Comparative Example 2

The preparation method of an anatase titanium dioxide nanosheet provided in this comparative example is the same as that of Example 1; and the preparation method of a titanium dioxide nanomaterial is basically the same as the preparation method of the amphiphilic titanium dioxide nanomaterial of Example 1, except that:
in step 2), a part by weight of the fatty acid compound is 1.

According to measurements, the prepared titanium dioxide nanomaterial has a grafting ratio of 0.2%, a contact angle of 2°, a specific surface area of 99.23 m²/g, a side length of 13.59 nm and a thickness of 2.6 nm.

The titanium dioxide nanomaterial provided in this comparative example is mixed with the deionized water, followed by controlling a concentration of the titanium dioxide nanomaterial to be 50 mg/L, and performing ultrasonic treatment for 15 min to obtain the nanofluid.

### Comparative Example 3

The preparation method of an anatase titanium dioxide nanosheet provided in this comparative example is the same as that of Example 1; and the preparation method of a titanium dioxide nanomaterial is different with the preparation method of the amphiphilic titanium dioxide nanomaterial of Example 1, specifically as follows:

2. Preparation of the titanium dioxide nanomaterial: reacting a mixture including 1 part by weight of the above anatase titanium dioxide nanosheet, 10 parts by weight of a fatty acid compound with 20 carbon atoms and a solvent at 25° C. for 3 h, then washing and filtering to obtain the titanium dioxide nanomaterial, where, according to measurements, the prepared titanium dioxide nanomaterial has a grafting ratio of 0%, a contact angle of 0°, a specific surface area of 99.23 m²/g, a side length of 13.59 nm and a thickness of 2.6 nm.

The titanium dioxide nanomaterial provided in this comparative example is mixed with the deionized water, followed by controlling a concentration of the titanium dioxide nanomaterial to be 50 mg/L, and performing ultrasonic treatment for 15 min to obtain the nanofluid.

### Test Example

Core oil displacement test is performed on the nanofluids prepared by Examples 1-9 and Comparative Examples 1-3, where sandstone core is used as the core and used for test in an oil displacement equipment, and the physical properties of core samples are shown in Table 1.

TABLE 1

| | Diameter | | | Permeability |
|---|---|---|---|---|
| Core number | (mm) | Height (mm) | Porosity (%) | (mD) |
| Example 1 | 24.93 | 100.03 | 14.22 | 3.23 |
| Example 2 | 25.09 | 99.86 | 14.56 | 4.55 |
| Example 3 | 24.98 | 100.02 | 15.39 | 2.32 |
| Example 4 | 25.19 | 100.06 | 13.37 | 2.37 |
| Example 5 | 25.36 | 100.19 | 15.19 | 3.58 |
| Example 6 | 25.01 | 100.17 | 14.27 | 3.91 |
| Example 7 | 24.99 | 99.94 | 14.33 | 2.22 |
| Example 8 | 24.87 | 10.29 | 15.26 | 2.93 |
| Example 9 | 25.03 | 99.89 | 15.47 | 2.71 |
| Comparative | 25.11 | 99.91 | 14.91 | 2.88 |
| Example 1 | | | | |
| Comparative | 25.09 | 100.27 | 14.16 | 3.04 |
| Example 2 | | | | |
| Comparative | 24.94 | 100.06 | 6.25 | 3.61 |
| Example 3 | | | | |

Before starting the oil displacement test, the core is vacuumed and saturated with water for 24 h. Then, an oil with a viscosity of 100 cP is pumped into the core, until no more water flows out; and at this time, the core reached an oil saturation state, and the volume of crude oil pumped into the core when the core is saturated is recorded as V₀. After the oil saturation, water is injected at a rate of 0.3 mL/min until no more oil flows out; and at this time, the volume of crude oil displaced by water displacement at this time is recorded as V₁. Then, the nanofluid is used for oil displacement, with the nanofluid being injected into the core at a rate of 0.3 mL/min until no more oil flows out. The volume of crude oil displaced by the nanofluid is measured and recorded as V₂. The water-displaced oil recovery, nanofluid-displaced oil recovery, and total oil recovery can be calculated using Equations 1, 2, and 3, respectively:

$$Water - displaced oil recovery ( \% ) = {V}_{1} / {V}_{0} \qquad Equation 1$$

$$Nanofluid - displaced oil recovery ( \% ) = {V}_{2} / {V}_{0} \qquad Equation 2$$

$$Total oil recovery ( \% ) = ( {V}_{1 +} {V}_{2 )} / {V}_{0} \qquad Equation 3$$

The test results are listed in Table 2.

TABLE 2

| | | Oil/water | | | |
|---|---|---|---|---|---|
| | | interfacial | | | Total oil |
| | Permeability | tension | Water-displaced | Nanofluid-displaced | recovery |
| Core number | (mD) | (mN/m) | oil recovery (%) | oil recovery (%) | (%) |
| Example 1 | 3.23 | 0.01 | 42.29 | 27.44 | 69.73 |
| Example 2 | 4.55 | 0.09 | 43.48 | 21.68 | 65.16 |
| Example 3 | 2.32 | 0.09 | 42.31 | 20.76 | 63.07 |
| Example 4 | 2.37 | 0.01 | 42.26 | 26.64 | 68.90 |
| Example 5 | 3.58 | 0.01 | 43.91 | 26.69 | 70.60 |
| Example 6 | 3.91 | 0.01 | 43.11 | 26.28 | 69.39 |
| Example 7 | 2.22 | 0.08 | 41.09 | 20.01 | 61.10 |
| Example 8 | 2.93 | 0.07 | 42.56 | 22.33 | 64.89 |
| Example 9 | 2.71 | 0.02 | 40.71 | 25.49 | 66.20 |
| Comparative | 2.88 | 3.45 | 42.59 | 8.36 | 50.95 |
| Example 1 | | | | | |
| Comparative | 3.04 | 8.36 | 43.99 | 5.43 | 49.42 |
| Example 2 | | | | | |
| Comparative | 3.61 | 10.22 | 42.51 | 2.29 | 44.80 |
| Example 3 | | | | | |

According to Table 2, it can be seen that the nanofluids prepared in Examples 1-9 have the higher oil recovery compared to the nanofluids prepared in Comparative Examples 1-3. Specifically, when the permeability of sandstone core is not higher than 4.55 mD, the oil recovery by the displacement with the nanofluid prepared according to the technical solution of the present disclosure is not less than 20.01%, and the total oil recovery is not less than 61.10%. It can be seen that the nanofluid provided by the disclosure can effectively improve the oil recovery of low-permeability oil reservoirs.

Finally, it should be noted that the above examples are only used to illustrate the technical solutions of the present disclosure, but not to limit them. Although the present disclosure has been described in detail with reference to the above examples, it should be understood by the skilled in art that the technical solutions described in the above examples can still be modified, or some or all technical features thereof can be equivalently replaced. However, these modifications or replacements do not make the essence of the corresponding technical solutions deviate from the scope of the technical solutions of various examples of the present disclosure.

What is claimed is:

1. An amphiphilic titanium dioxide nanomaterial, comprising: an anatase titanium dioxide nanosheet and a carbon chain grafted on a surface of the anatase titanium dioxide nanosheet via an ester bond, wherein the carbon chain has a carbon atom number of 8-30, and a grafting ratio of the amphiphilic titanium dioxide nanomaterial is 5%-45%.

2. The amphiphilic titanium dioxide nanomaterial according to claim 1, wherein the carbon chain has a carbon atom number of 10-26.

3. The amphiphilic titanium dioxide nanomaterial according to claim 1, wherein the grafting ratio of the amphiphilic titanium dioxide nanomaterial is 5%-35%.

4. The amphiphilic titanium dioxide nanomaterial according to claim 2, wherein the grafting ratio of the amphiphilic titanium dioxide nanomaterial is 5%-35%.

5. The amphiphilic titanium dioxide nanomaterial according to claim 1, wherein a contact angle of the amphiphilic titanium dioxide nanomaterial is 0-70°.

6. The amphiphilic titanium dioxide nanomaterial according to claim 2, wherein a contact angle of the amphiphilic titanium dioxide nanomaterial is 0-70°.

7. The amphiphilic titanium dioxide nanomaterial according to claim 3, wherein a contact angle of the amphiphilic titanium dioxide nanomaterial is 0-70°.

8. The amphiphilic titanium dioxide nanomaterial according to claim 1, wherein the carbon chain has a carbon atom number selected from one of 8, 10, 12, 14, 16, 18, 20, 22, 24, 26, 28, 30, or a value within a range consisting of any two selected carbon atom numbers.

9. The amphiphilic titanium dioxide nanomaterial according to claim 1, wherein the grafting ratio is selected from one of 5%, 10%, 15%, 20%, 25%, 30%, 35%, 40%, 45%, or a value within a range consisting of any two selected grafting ratios.

10. The amphiphilic titanium dioxide nanomaterial according to claim 1, wherein the amphiphilic titanium dioxide nanomaterial has a specific surface area of 80-150 m²/g, a thickness of 2-4 nm, and a side length of 10-30 nm.

11. The amphiphilic titanium dioxide nanomaterial according to claim 5, wherein the contact angle is selected from one of 0°, 10°, 20°, 30°, 40°, 50°, 60°, 70°, or a value within a range consisting of any two selected contact angles.

12. A preparation method of the amphiphilic titanium dioxide nanomaterial according to claim 1, comprising the following steps:
reacting a mixture containing 1 part by weight of an anatase titanium dioxide nanosheet, 2-20 parts by weight of a fatty acid compound and a solvent at 40-80° C. with a rotation speed of 100-1000 rpm for 4-24 h, washing and filtering to obtain the amphiphilic titanium dioxide nanomaterial;
wherein the fatty acid compound has a carbon atom number of 8-30.

13. The preparation method according to claim 12, wherein the fatty acid compound is 4-15 parts by weight.

14. The preparation method according to claim 12, wherein a reaction temperature is 60-80° C., a reaction rotation speed is 200-800 rpm, and a reaction time is 6-12 h.

15. A nanofluid, comprising the amphiphilic titanium dioxide nanomaterial according to claim 1 and a solvent, wherein the solvent comprises one of saline water and deionized water.

16. The nanofluid according to claim 15. wherein the amphiphilic titanium dioxide nanomaterial has a concentration of 10-1000 mg/L.

17. An oil recovery method, comprising recovering an oil reservoir by the nanofluid according to claim 15.
